(19) United States
(12) Patent Application Publication
(10) Pub. No.: US 2003/0179805 A1
(43) Pub. Date: Sep. 25, 2003

(54) Capacitance type humidity sensor with passivation layer

(76) Inventors: Kazuaki Hamamoto, Nagoya-city (JP); Inao Toyoda, Anjo-city (JP)

Correspondence Address: POSZ & BETHARDS, PLC, 11250 ROGER BACON DRIVE, SUITE 10, RESTON, VA, 20190, US

(21) Appl. No.: 10/374,102

(22) Filed: Feb. 27, 2003

(30) Foreign Application Priority Data
Mar. 20, 2002 (JP) 2002-78136

(51) Int. Cl. G01N 25/02

(52) U.S. Cl. 374/16

(57) ABSTRACT

A capacitance type humidity sensor is composed of a substrate, two electrodes, a passivation layer, and a humidity-sensitive layer. The two electrodes are disposed on the substrate and on the same plane, and face each other with spacing therebetween. The passivation layer covers the two electrodes. The humidity-sensitive layer is disposed on the spacing or between the spacing, and the dielectric constant of the humidity-sensitive layer is changed corresponding to humidity. As the spacing is broadened, the hysteresis in the humidity sensor is reduced. Especially, when the spacing is twice or more larger than the film thickness of the passivation layer, the hysteresis is reduced to be less than 10 % RH in relative humidity.

### CROSS REFERENCE TO RELATED APPLICATION

This application relates to and incorporates herein by reference Japanese Patent Application No. 2002-78136 filed on Mar. 20, 2002.

### FIELD OF THE INVENTION

The present invention relates to a capacitance type humidity sensor with a passivation layer.

### BACKGROUND OF THE INVENTION

A capacitance type humidity sensor is proposed in Japanese Patent No. H11-101766A and in Japanese Utility Model No. H5-23124U. This humidity sensor involves a pair of comb-shape electrodes, which are formed on a substrate and also on the same plane. A pair of comb-tooth electrodes of the pair of comb-shape electrodes faces each other. Therefore, the pair of comb-shape electrodes forms a capacitor. The pair of comb-shape electrodes is covered with a humidity-sensitive film, which is disposed on the substrate. The humidity-sensitive film is composed of polyimide polymer, and is also disposed between the pair of comb-tooth electrodes. The humidity-sensitive film can absorb moisture around the humidity sensor. When the moisture changes, the absorbed moisture also changes. Then, a dielectric constant of the humidity-sensitive film changes, and an electrostatic capacity of the above capacitor also changes together with changing of the dielectric constant. As a result, the humidity sensor detects the humidity at an atmosphere by measuring the electrostatic capacity of the capacitor.

In this humidity sensor, the humidity-sensitive film directly contacts with the pair of comb-shape electrodes, which is made of metallic material or the like. Accordingly, the electrodes are exposed to the moisture, which is absorbed into the humidity-sensitive film and passes through the humidity-sensitive film. Then, the electrodes are degraded, and the durability in the humidity sensor declines. To avoid this degradation of the electrodes, a passivation film is formed on the substrate to cover the pair of comb-shape electrodes, which is proposed in United States Patent Application Publication No. U.S. 2002-0141136-A1. However, the humidity sensor with the passivation film shows a large hysteresis, which appears between increasing and decreasing curves of the electrostatic capacity of the capacitor when the humidity increases and decreases respectively. This hysteresis causes a decrease of measuring accuracy.

There is another capacitance type humidity sensor such as a parallel-plate type humidity sensor. The parallel-plate type humidity sensor involves a pair of electrode plates, which faces each other. A humidity-sensitive film is sandwiched between the pair of electrode plates. For example, the parallel-plate type humidity sensor according to Japanese Patent S60-166854A is composed of a lower electrode plate, which is formed on a substrate, a humidity-sensitive film, which is formed on the lower electrode plate, and an upper electrode plate, which is formed on the humidity-sensitive film. Therefore the humidity-sensitive film is sandwiched between the upper and lower electrode plates. The upper electrode plate has moisture permeability and is exposed outside. So the hysteresis in this humidity sensor is sufficiently small because the absorbed moisture in the humidity-sensitive film evaporates through the upper electrode plate. However, the durability for moisture of the upper electrode plate declines because the upper electrode plate is made of metallic material and, for example, the metallic material rust by the absorbed moisture. Moreover, when the upper electrode plate is formed by vacuum evaporation or spattering method, the humidity-sensitive film is scattered in a chamber, in which the humidity sensor is placed as a work piece. Therefore, the chamber is contaminated with the scattered humidity-sensitive film.

### SUMMARY OF THE INVENTION

The present invention has an object to reduce a hysteresis in a capacitance type humidity sensor. Further, the present invention has another object to raise durability of a humidity sensor.

A capacitance type humidity sensor is composed of a substrate, two electrodes, a passivation layer, and a humidity-sensitive layer. The two electrodes are made of metallic material, disposed on the substrate and on the same plane, and face each other with spacing therebetween. The passivation layer, which is made of silicon nitride, covers the two electrodes and the spacing. The humidity-sensitive layer is made of high polymer organic material having absorbent property, and is disposed on the spacing or between the spacing. The dielectric constant of the humidity-sensitive layer is changed corresponding to humidity. It is preferred that an insulating film is disposed on the substrate, and the two electrodes are formed on the insulating layer.

More particularly, the two electrodes are composed of a pair of base electrodes and comb-tooth electrodes, which extend from the base electrodes. The pair of comb-tooth electrodes of the two electrodes alternately faces each other. The spacing is defined as spacing between the pair of comb-tooth electrodes of the two electrodes.

When the spacing is broadened, the hysteresis in the humidity sensor is reduced. Especially, when the spacing is twice or more larger than the film thickness of the passivation layer, the hysteresis is reduced to be less than 10% RH in relative humidity. Moreover, when the spacing is three times or more larger than the film thickness of the passivation layer, the hysteresis is reduced to be less than 5% RH in relative humidity.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic plan view showing a capacitance type humidity sensor according to an embodiment of the present invention;

FIG. 2 is a schematic cross-sectional view showing the humidity sensor taken along line II-II in FIG. 1;

FIG. 3 is a graph showing a relation between relative humidity and change of electrostatic capacity of the humidity sensor, in which spacing between a pair of comb-tooth electrodes is 1.5 microns and film thickness of a silicon nitride layer is 1.6 microns;

FIG. 4 is a graph showing a relation between relative humidity and change of electrostatic capacity of the humidity sensor, in which the spacing between the pair of comb-tooth electrodes is 5 microns and the film thickness of the silicon nitride layer is 1.6 microns;

FIG. 5 is a graph showing a relation between spacing between the pair of comb-tooth electrodes in the humidity sensor and maximum hysteresis distortion in various film thickness of the silicon nitride layer (solid lines) and in a parallel plate type humidity sensor (a dotted line); and

FIGS. 6A to 6C are schematic cross-sectional views showing shapes of a groove in silicon nitride layer in various spacing between the pair of comb-tooth electrodes in the humidity sensor.

### DETAILED DESCRIPTION OF THE PREFERRED EMBODIMENT

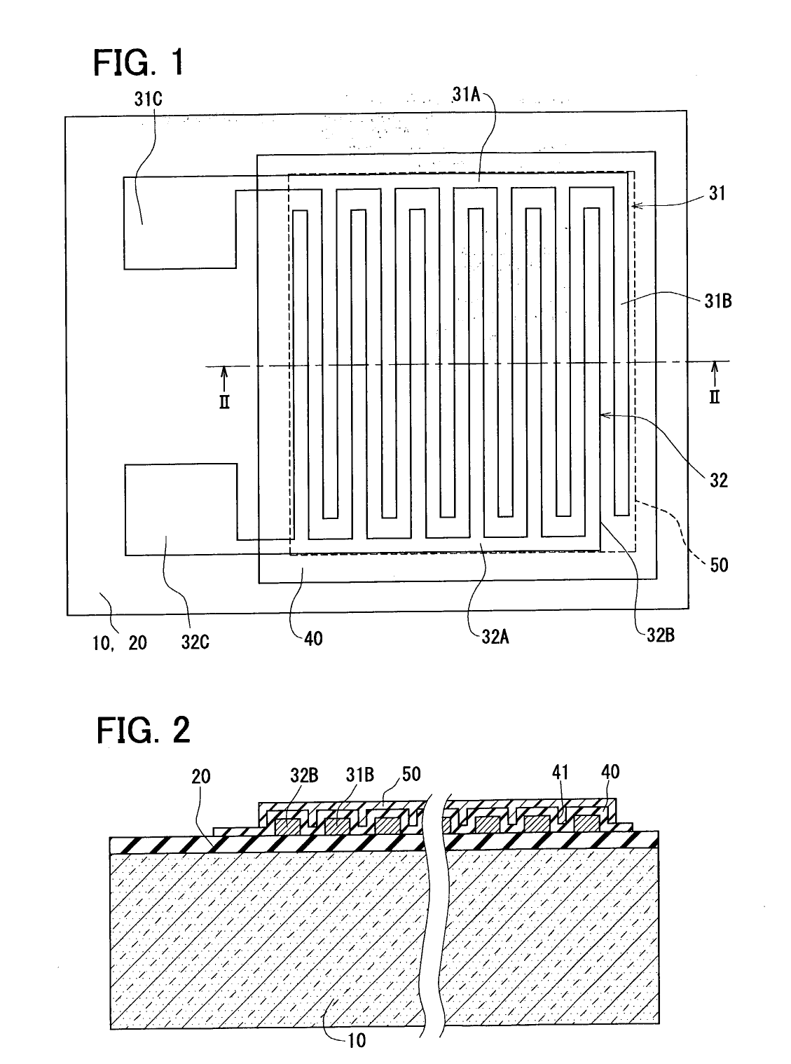

A capacitance type humidity sensor, as shown in FIGS. 1 and 2, has a semiconductor substrate 10, which is made of silicon. On the surface of the semiconductor substrate 10, a silicon oxide layer 20 is deposited as an insulating layer. Then, a pair of electrodes 31, 32 is disposed on the silicon oxide layer 20 and on the same plane. The electrodes 31, 32 are made of metallic material such as aluminum, copper, gold, platinum and so on. The metallic material is deposited on the silicon oxide layer 20 on the semiconductor substrate by vacuum evaporation or spattering method, and is etched into a pair of comb-shape electrodes. Here, the shapes of the pair of electrodes 31, 32 are not limited to the comb-shape.

In this embodiment, the electrodes 31, 32 are composed of electrode pads 31C, 32C, base electrodes 31A, 32A, and plural comb-tooth electrodes 31B, 32B, which extend from the base electrodes 31A, 32A respectively. Each comb-tooth electrode 31B, 32B is located alternately to face each other. Therefore, the pair of comb-shape electrodes 31, 32 forms a capacitor. By using the comb-shape pattern as the electrodes 31, 32, a layout area of the electrodes 31, 32 is minimized, and a total facing area between a pair of comb-tooth electrodes 31B, 32B is maximized. Accordingly, a detectable change of electrostatic capacity of the capacitor between the pair of electrodes 31, 32 is maximized. The electrode pads 31C, 32C are used as connectors for connecting to an external signal processor (not shown).

The signal processor measures an electrostatic capacity of the capacitor between the pair of electrodes 31, 32 and detects a change of electrostatic capacity. The electrode pads 31C, 32C need to expose outside so that the electrode pads 31C, 32C are used as the connecters for connecting with the external signal processor. Therefore, the electrode pads 31C, 32C are not covered with a passivation layer. However, the signal processor may be formed on the same semiconductor substrate 10 so that the electrode pads 31c, 32c can be covered with the passivation layer.

Then, a silicon nitride layer 40 as the passivation layer is deposited on the semiconductor substrate 10 so that the silicon nitride layer 40 covers the pair of electrodes 31, 32. The silicon nitride layer 40 is, for example, deposited by plasma chemical vapor deposition (i.e., plasma CVD) so that the film thickness of the silicon nitride layer 40 on the semiconductor substrate 10 is uniform in each portion.

Then, a humidity-sensitive layer 50 is formed on the silicon nitride layer 40. As shown by a dotted line in FIG. 1, the humidity-sensitive layer 50 covers the pair of electrodes 31, 32 except for the electrode pads 31c, 32c. The humidity-sensitive layer 50 is composed of high polymer organic material, which is absorbent of moisture. For example, the humidity-sensitive layer 50 is made of polyimide polymer, cellulose acetate butyrate (i.e., CAB), or the like. The humidity-sensitive layer 50 is formed as follows. The high polymer organic material is coated on the silicon nitride layer by spin-coat method or screen-stencil method. After that, the high polymer organic material is hardened.

When moisture in atmosphere around the humidity sensor is absorbed into the humidity-sensitive layer 50, the dielectric constant of the humidity-sensitive layer 50 is changed corresponding to the absorbed moisture. This change of the dielectric constant of the humidity-sensitive layer 50 is large enough to be detected, because the dielectric constant of H₂O in the absorbed moisture is sufficiently large. The pair of comb-shape electrodes 31, 32 forms a capacitor, which has the humidity-sensitive layer 50 as a dielectric. Then, the electrostatic capacitance of the capacitor is changed corresponding to the change of the dielectric constant of the humidity-sensitive layer 50. The absorbed moisture in the humidity-sensitive layer 50 corresponds to humidity in the atmosphere, where the humidity sensor is placed. Therefore, the humidity is detected by measuring the change of the electrostatic capacitance of the capacitor.

As shown in FIG. 2, the humidity-sensitive layer 50 is formed on the silicon nitride layer 40, not formed directly on the electrodes 31, 32. A groove 41 is formed on the silicon nitride layer 40 between the pair of comb-tooth electrodes 31B, 32B, which faces each other, because the film thickness of the silicon nitride layer 40 is uniform in each portion on the semiconductor substrate 10.

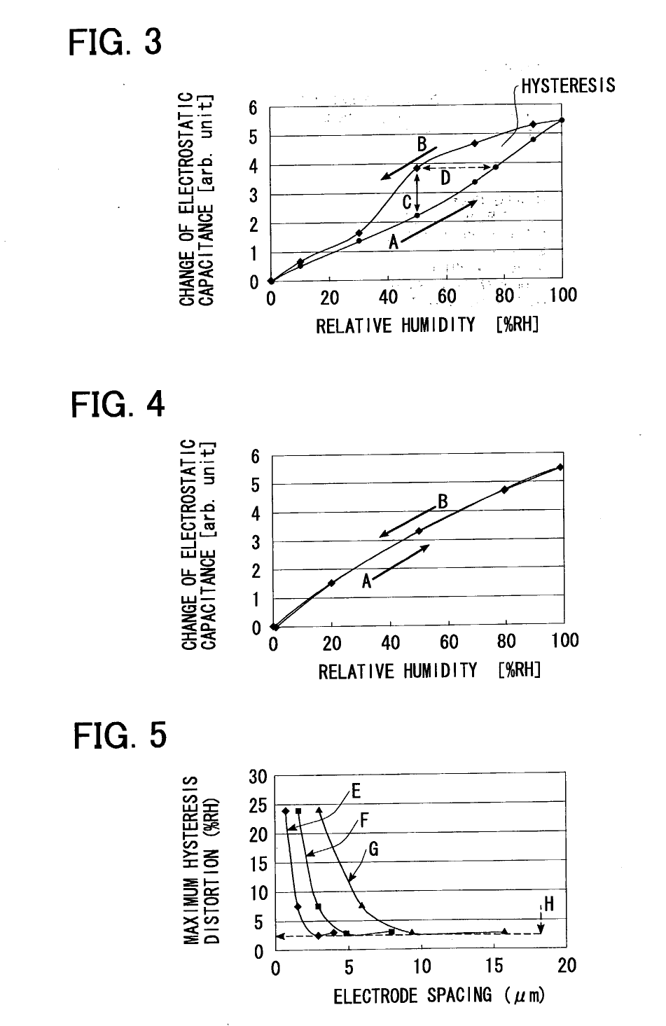

Considering the related art, the humidity sensor with a passivation film is manufactured as a trial. In this case, the humidity sensor shows a relation between relative humidity and change of electrostatic capacity of the humidity sensor, as shown in FIG. 3. In FIG. 3, the horizontal axis shows a relative humidity in the atmosphere around the humidity sensor, and the vertical axis shows a change of the electrostatic capacitance of the humidity sensor. The vertical axis is normalized by the electrostatic capacitance at 0% RH. A represents an increasing curve of the change of the electrostatic capacitance of the humidity sensor in a case that the relative humidity increases from 0% RH to 100% RH. B represents a decreasing curve of the change in a case that the relative humidity decreases from 100% RH to 0% RH. C represents a maximum difference of the change of electrostatic capacity between the increasing curve and the decreasing curve. The maximum difference C of the change of electrostatic capacity is converted in relative humidity, so that a maximum hysteresis distortion D is calculated. The maximum difference C and the maximum hysteresis distortion D are mentioned later. In FIG. 3, a hysteresis appears between the increasing curve and the decreasing curve of the change of electrostatic capacity when the relative humidity increases and decreases respectively. Here, in this humidity sensor, spacing between the electrodes 31B, 32B is 1.5 microns, and the film thickness of the silicon nitride layer is 1.6 microns.

According to the above trial, it is considered that the hysteresis may be caused as follows. The humidity-sensitive layer 50 in the groove 41 strongly affects the electrostatic capacity corresponding to the humidity in the atmosphere. That is because the humidity-sensitive layer 50 in the groove 41 is located between the pair of comb-tooth electrodes 31B, 32B and is adjacent to the pair of comb-tooth electrodes 31B, 32B. However, the humidity-sensitive layer 50 in the groove 41 is also sandwiched by the silicon nitride layer 40 in the groove 41.

When moisture is absorbed from the surface of the humidity-sensitive layer 50 and passes through and reaches to the humidity-sensitive layer 50 in the groove 41, it is difficult to evaporate the moisture in the humidity-sensitive layer 50 in the groove 41 because the humidity-sensitive layer 50 in the groove 41 is sandwiched by the silicon nitride layer 40, which has low moisture permeability.

In a case that the relative humidity in the atmosphere around the humidity sensor decreases from 100% RH to 0% RH, an evaporation of the moisture in the humidity-sensitive layer 50 in the groove 41 is delayed. Therefore, the excess moisture in the humidity-sensitive layer 50 in the groove 41 increases the electrostatic capacitance of the capacitor. In a case that the relative humidity increases from 0% RH to 100% RH, the above increase of the electrostatic capacitance of the capacitor does not occur. Therefore, a hysteresis appears between increasing and decreasing curves of the change of the electrostatic capacity of the capacitor when the relative humidity increases and decreases respectively.

Therefore, it is considered that the moisture in the humidity-sensitive layer 50 in the groove 41 may move easily and be evaporated rapidly if the groove 41 is broadened. Then, the hysteresis may be reduced. In this embodiment, to broaden the groove 41, spacing between the pair of comb-tooth electrodes 31B, 32B is broadened. In detail, in the above trial, the spacing between the electrodes 31B, 32B is 1.5 microns and the film thickness of the silicon nitride layer 40 is 1.6 microns. Compared with the above trial, the humidity sensor, in which the spacing between the electrodes 31B, 32B is 5 microns and the film thickness of the silicon nitride layer 40 is 1.6 microns, is manufactured and tested.

In this case, the humidity sensor shows a relation between the relative humidity and the change of electrostatic capacity of the humidity sensor, as shown in FIG. 4. In FIG. 4, A represents the increasing curve of the change of electrostatic capacitance of the humidity sensor in a case that the relative humidity increases from 0% RH to 100% RH, and B represents the decreasing curve of the change in a case that the relative humidity decreases from 100% RH to 0% RH. Here, the increasing and decreasing curves of the change of electrostatic capacity in relation to the relative humidity are almost the same, and the hysteresis is not observed apparently. It is confirmed that the hysteresis is reduced when the spacing between the comb-tooth electrodes 31B, 32B is broadened.

Furthermore, the width of the groove 41 is defined not only by the spacing between the pair of comb-tooth electrodes 31B, 32B but also by the film thickness of the silicon nitride layer 40. Therefore, the humidity sensor, which has various film thickness of the silicon nitride layer 40, is manufactured and tested, as shown in FIG. 5.

In FIG. 5, a curve E represents the humidity sensor in which the film thickness of the silicon nitride layer is 0.8 microns. A curve F represents the humidity sensor in which the film thickness is 1.6 microns. A curve G represents the humidity sensor in which the film thickness is 3.2 microns. A curve H represents the parallel plate type humidity sensor. The maximum hysteresis distortion is calculated as follows. As shown in FIG. 3, the maximum difference C of the change of electrostatic capacity between the increasing curve and the decreasing curves is converted in relative humidity, so that the maximum hysteresis distortion D is calculated.

In a case that the film thickness of the silicon nitride layer 40 is 0.8 microns, the maximum hysteresis distortion is larger-than 20% RH when the spacing between the pair of comb-tooth electrodes 31B, 32B is less than 1 micron, as indicated by the curve E. However, when the spacing between the electrodes 31B, 32B is about 1.6 microns, which is twice larger than the film thickness of the silicon nitride layer 40, the maximum hysteresis distortion is reduced to 8% RH, which is less than 10% RH. Moreover, when the spacing between the electrodes 31B, 32B is about 2.4 microns, which is three times larger than the film thickness of the silicon nitride layer 40, the maximum hysteresis distortion is reduced to 3% RH, which is less than 5% RH. Such tendency to reduce the maximum hysteresis distortion in accordance with broadening the spacing also appears in cases that the film thickness of the silicon nitride layer 40 is 1.6 microns and 3.2 microns, as indicated by the curves F, G, respectively.

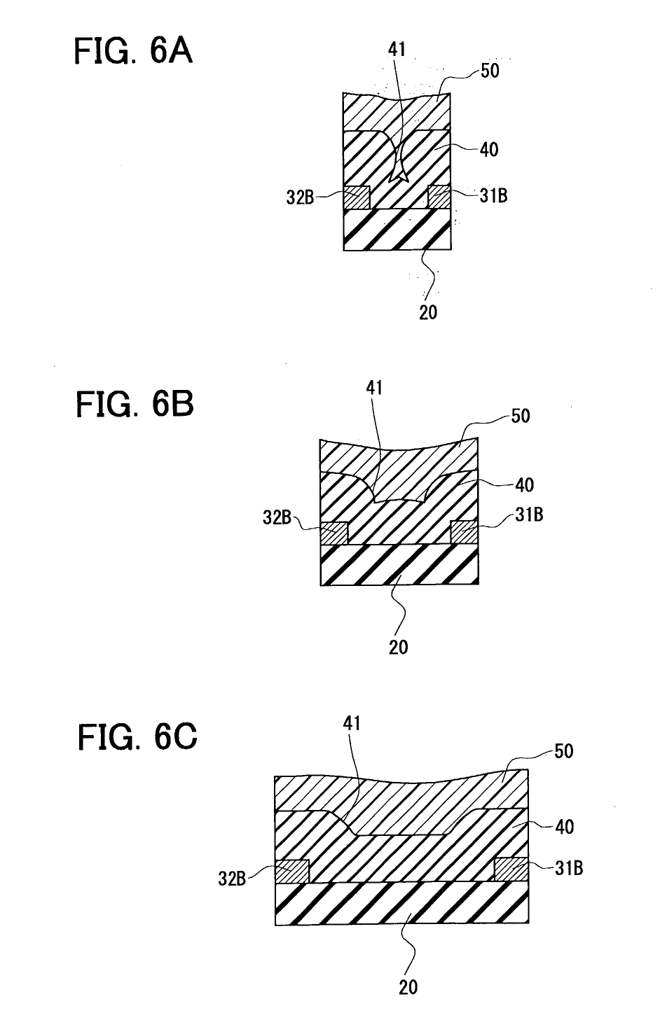

Further, the cross-sections of the groove 41 on the silicon nitride layer 40 in various spacing are observed, as shown in FIGS. 6A to 6C. FIGS. 6A to 6C show the humidity sensors in which the spacing are 1.5, 3.0, and 5.0 microns, respectively. Here, the film thickness of the silicon nitride layer 40 is 1.6 microns in each humidity sensors. As shown in FIG. 6A, when the spacing is 1.5 microns, the opening of the groove 41 on the silicon nitride layer 40 is narrow and the groove 41 is deep. However, when the spacing are 3.0 microns and 5.0 microns shown in FIG. 6B and 6C, respectively, which are twice and three times larger than the film thickness of the silicon nitride layer, the openings of the grooves 41 are sufficiently wide.

Considering the result of the film thickness dependency of the maximum hysteresis distortion shown in FIG. 5, it is preferred that the spacing is twice larger than the film thickness of the silicon nitride layer 40. In this case, the maximum hysteresis distortion is reduced to 8% RH, and the opening of the groove 41 is substantially wide. Then, the humidity sensor is practically and economically used.

Moreover, when the spacing is three times larger than the film thickness of the silicon nitride layer 40, the maximum hysteresis distortion is reduced to 3% RH, and the humidity sensor detects relative humidity with higher accuracy.

There is another capacitor type humidity sensor, such as a parallel-plate type humidity sensor. This parallel-plate type humidity sensor has the maximum hysteresis distortion of about 3% RH, as shown by a curve H in FIG. 5. Therefore, the humidity sensor according to this embodiment shows almost the same maximum hysteresis distortion as the parallel-plate type humidity sensor has.

Furthermore, the humidity sensor according to this embodiment is manufactured in a conventional semiconductor manufacturing line because no contamination problem occurs in manufacturing the humidity sensor according to this embodiment, compared with the parallel-plate type humidity sensor, which has a problem that a manufacturing line is contaminated.

What is claimed is:

1. A capacitance type humidity sensor, comprising:
a substrate;
two electrodes disposed on the substrate and on the same plane so as to face each other with spacing therebetween;
a passivation layer disposed on the two electrodes so as to cover the two electrodes; and
a humidity-sensitive layer that directly contacts the passivation layer so as to cover the two electrodes, the humidity-sensitive layer having a dielectric constant which changes according to ambient humidity,
wherein the spacing is twice or more larger than the film thickness of the passivation layer.

2. A capacitance type humidity sensor according to claim 1, wherein the spacing is three times or more larger than the film thickness of the passivation layer.

3. A capacitance type humidity sensor according to claim 1, wherein the passivation layer is made of silicon nitride.

4. A capacitance type humidity sensor according to claim 1, further comprising an insulating film disposed between the substrate and the two electrodes.

5. A capacitance type humidity sensor according to claim 1,
wherein each of the two electrodes is composed of a base electrode and a plurality of comb-tooth electrodes, which extend from the base electrode,
wherein the plurality of comb-tooth electrodes of the two electrodes alternately face each other, and
wherein the spacing is defined as spacing between the pair of comb-tooth electrodes of the two electrodes.

6. A capacitance type humidity sensor according to claim 1, wherein the humidity-sensitive layer is made of high polymer organic material that is absorbent of moisture.

7. A capacitance type humidity sensor according to claim 1, wherein the two electrodes are made of metallic material.

8. A capacitance type humidity sensor according to claim 1, wherein the substrate is made of semiconductor material.

9. A capacitance type humidity sensor according to claim 1, wherein the spacing is less than 10 microns, and the film thickness of the passivation layer is less than 3.2 microns.
